(19) United States
(12) Patent Application Publication
(10) Pub. No.: US 2024/0346255 A1
(43) Pub. Date: Oct. 17, 2024

(54) CONTEXTUAL KNOWLEDGE SUMMARIZATION WITH LARGE LANGUAGE MODELS

(71) Applicant: MICROSOFT TECHNOLOGY LICENSING, LLC, Redmond, WA (US)

(72) Inventors: Sebastian Johannes BLOHM, Munich (DE); Dmitriy MEYERZON, Bellevue, WA (US); Aaron Lee HALFAKER, Seattle, WA (US); James John HENSMAN, Cambridge (GB)

(21) Appl. No.: 18/135,051

(22) Filed: Apr. 14, 2023

(51) Int. Cl. G06F 40/40; G06F 16/332; G06F 21/62; G06F 40/166; G06F 40/35

(52) U.S. Cl. CPC G06F 40/40; G06F 16/3329; G06F 21/6227; G06F 40/166; G06F 40/35

(57) ABSTRACT

The techniques disclosed herein enable systems to enhance the efficiency and functionality of knowledge base systems through automated generation of knowledge base content such as topic definitions using a large language model. This is accomplished by utilizing a summarization module that processes incoming requests pertaining to a knowledge base topic. In response to a request, the summarization module can retrieve information related to the topic and generate an instruction directing a large language model to generate a natural language output. By generating the instruction from the specific context of the knowledge base, the disclosed techniques can ensure that outputs received from the large language model are consistent and relevant. In addition, content that was generated based on privileged information such as an access-controlled document can receive the same access controls to maintain information security. Furthermore, large language model outputs can undergo a review and editing process to ensure accuracy.

### BACKGROUND

As modern work and collaboration environments become increasingly distributed, more and more functions are provided over connected network services such as cloud computing services. For example, a team of workers may be located around the world and collaborate remotely with each other. Therefore, the team can utilize an organized database of information, also known as a knowledge base (KB), to onboard new members in lieu of in-person orientations. Typically, information within a knowledge base can be produced and curated by contributors who are well versed in relevant subject matter. In addition, a knowledge base can be an important tool for maintaining internal institutional knowledge (e.g., for employees) as well as enabling cohesive communications with external organizations such as users, customers, and partners. As such, knowledge bases can be configured as a public resource and/or a private internal database.

Furthermore, knowledge bases can be organized into constituent topics. For instance, a first topic can provide information on a particular product while a second topic can relate to a certain portion of an organization (e.g., a human resource department). In various examples, the knowledge base can utilize an automated process to collect internal information and generate topics. Unfortunately, many modern knowledge bases can be very large, containing thousands or even millions of individual topics. As such, some topics, especially those that are generated automatically, may lack crucial information. It is with respect to these and other considerations that the disclosure made herein is presented.

### SUMMARY

The techniques disclosed herein provide systems for enhancing knowledge base (KB) operations through knowledge summarization and curation by a large language model (LLM). Large language models have seen widespread adoption due to their diverse processing capabilities in vision, speech, language, and decision making. Unlike other artificial intelligence (AI) models such as recurrent neural networks and long short-term memory (LSTM) models, transformer-based large language models make use of a native self-attention mechanism to identify vague context from limited available data and even synthesize new content from images and music to software.

A large language model is an AI tool that utilizes a formal representation of the probability distribution of sequences of tokens in text. Tokens are sub-units of text and, depending on the implementation, can be words, characters or (most commonly in modern implementations) units of arbitrary length comprising anything from single characters to sequences of words or special characters. At the heart of large language models is the ability to predict which token is the most likely to follow any given sequence of tokens. This predictive ability is trained using large collections of publicly available text samples (e.g., an online dataset).

The ability of large language models to identify and work within vague or indefinite contexts allows large language models to achieve high quality natural language outputs (e.g., text). This ability can be leveraged in various scenarios such as text summarization where an understanding of context and fluency in a natural language (e.g., English) is important. Moreover, large language models can ingest large amounts of training data and maintain learnings across diverse application spaces. That is, information, techniques, and other training data can be learned once and applied repeatedly.

However, commensurate with their capabilities, large language models are complex, oftentimes comprising millions if not billions of individual parameters and are trained using large publicly available datasets. As such, a large language model may be poorly adapted to the specific context of a particular knowledge base. For example, requesting a large language model to generate information about a human resource department of a specific organization (e.g., an enterprise or company, an agency, an educational institution) may result in a general overview of the functions of a human resource department. Consequently, the information synthesized by the large language model may not be useful for the organization associated with the present knowledge base. In contrast, the present techniques can constrain the large language model through targeted instructions that ensure large language outputs are relevant and suit the context of a given knowledge base. In various examples, this can be referred to as grounding the large language model where the retrieved information serves as the grounding context. It should be understood that while the examples discussed herein generally relate to an enterprise context, the disclosed techniques can be utilized in any suitable scenario.

To accomplish this, the disclosed system can utilize a summarization module that can be configured to receive an initialization request that defines a target topic and an output format. In a specific example, the target topic can be “project alpha” in reference to a specific project in development by an organization that operates the knowledge base. In addition, the output format can be a “definition” requesting a summary of the functions, goals, and other aspects of the “project alpha” topic. The initialization request can be generated manually such as via a user command or automatically for a regular time interval as part of an automated update process (e.g., once a week).

In response to the initialization request, the summarization module can proceed to retrieve relevant information from a preconfigured data source such as the knowledge base. The retrieved information can include documents, images, multimedia files, topic properties, related topics, internal messages, internal sites or pages, and the like. The relevance of the retrieved information can be determined based on a preexisting connection to the target topic (e.g., an existing entry in the knowledge base), a user connection such as content that is generated by a user associated with the target topic, and other measures of relevance. Furthermore, the summarization module can optionally retrieve additional unstructured information from external content sources in addition to the knowledge base. For instance, the organization that operates the knowledge base may have a business relationship with an external partner. As such, the summarization module can retrieve external information to generally describe the external partner while information from the knowledge base can relate to specific aspects of the relationship between the organization and the external partner. In various examples, unstructured information can be any content that is not specifically formatted for automated processing (e.g., machine learning training).

The retrieved information can be accordingly utilized by the summarization module along with the initialization request to generate an instruction for the large language model. Commonly referred to as a “prompt”, the instruction can be a natural language statement that configures the large language model to execute a specified task. In a basic example, an instruction can command a large language model to “generate a summary of the following document.” Due to the complexity of large language models, aspects of the instruction such as phrasing, word choice, format, and types of information provided can affect the performance and output of the large language model. Consequently, the summarization module can employ a specialized algorithm to generate the instruction.

Accordingly, the large language model can respond to the instruction with a natural language output. Generally described, the natural language output can synthesize the information extracted from the knowledge base and/or the external source in a configuration that conforms to the output format specified by the initialization request. The natural language input can be evaluated and/or edited by a user, a content management system, or other entity. Subsequently, in response to a confirmation input, the natural language output can be published to the knowledge base. Alternatively, the natural language output may simply be consumed by a user (e.g., read, heard) and not confirmed, published, or otherwise made available to other users. As such, the other users can themselves request a natural language output generation from the system.

In this way, the disclosed techniques address several technical challenges of managing a knowledge base. In a first example of the technical benefit of the present disclosure, utilizing a large language model for generating knowledge base content can enable seamless integration of information across multiple disparate sources (e.g., a webpage, a design document, and a video). In many existing approaches, such synthesis may be impossible or impractical often requiring preprocessing of existing content for compatibility with templates or other structures. In a similar way, by utilizing a large language model to infer the context of a given topic, the systems presented herein do not rely on the copying of preexisting content employed by existing methods which may or may not be available across all topics of a knowledge base. This can lead to a consistent level of performance regardless of the availability and/or format of existing information.

In another example of the technical benefit of the present disclosure, utilizing a large language model can enable greater flexibility in the format and style of outputs. For example, a large language model can be configured with support for many languages (e.g., English, Chinese, Italian) and can thus generate outputs in those languages irrespective of the original language of the source information to enable multilingual support in a knowledge base without additional components. For example, the large language model can generate a Japanese language description of a product based on information from a document originally written in English. In addition, the large language model can be configured to adopt a consistent style of output to conform with style guides, communication guidelines, and other organizational rules.

In still another example of the technical benefit of the present disclosure, the present system can ensure accountability, correctness, and security for knowledge base information. For instance, by including the confirmation input mentioned above, the natural language outputs of the large language model can receive additional review prior to publication in a potentially public facing context. In an illustrative example, the large language model may generate a definition for a knowledge base topic that contains restricted information requiring access privileges. Accordingly, the resultant natural language output can likewise include these access privilege requirements thereby maintaining the original security of the knowledge base. In addition, the confirmation input can enable external validation (e.g., a human expert) of the information presented by the large language model. Accordingly, the disclosed techniques can reduce the manual effort required for knowledge base content generation while continuing to leverage human expertise to maintain accuracy and privacy. In this way, the disclosed system can address technical challenges facing utilizing a large language model to generate information.

Moreover, knowledge base information can be retrieved by the summarization module based on the access permissions of a current user. For example, the user may not have permission to access all the content of the knowledge base. As such, the system can omit content which the user cannot access from consideration when generating information. In this way, the disclosed system can enforce access controls for privileged knowledge base content.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIG. 1 is a block diagram of a system for generating information for a knowledge base topic utilizing a large language model and information extracted from the knowledge base.

FIG. 2 illustrates an example operational flow of a summarization module generating an instruction for a large language model.

FIG. 3A illustrates an example operational flow of a summarization module generating an instruction for a large language model in a first phase of operation.

FIG. 3B illustrates an example operational flow of a summarization module generating an instruction for a large language model in a second phase of operation.

FIG. 4A illustrates an example user interface for requesting a definition for a knowledge base topic from a large language model in a first phase of operation.

FIG. 4B illustrates an example user interface for requesting a definition for a knowledge base topic from a large language model in a second phase of operation.

FIG. 4C illustrates an example user interface for asking questions of a knowledge base topic in a freeform manner.

FIG. 5 is a flow diagram showing aspects of a routine for generating information for a knowledge base topic utilizing a large language model and information extracted from the knowledge base.

FIG. 6 is a computer architecture diagram illustrating an illustrative computer hardware and software architecture for a computing system capable of implementing aspects of the techniques and technologies presented herein.

FIG. 7 is a diagram illustrating a distributed computing environment capable of implementing aspects of the techniques and technologies presented herein.

### DETAILED DESCRIPTION

The techniques described herein enhance the operation of knowledge base systems by utilizing a large language model to generate information that is relevant to the specific context of the knowledge base. As mentioned above, utilizing a large language model in the context of a knowledge base can involve several technical challenges. For example, the high complexity and unspecific nature of large language models can result in natural language outputs that are irrelevant to the specific information of the knowledge base. In another example, the behavior of the large language model can depend heavily on the formatting of instructions provided to the large language model such phrasing, word choice, example outputs, and so forth.

However, addressing these technical challenges using the techniques described herein enables several technical benefits that improve efficiency, accessibility, and usability of knowledge base systems. For instance, generating content such as topic definitions using a large language can reduce and even eliminate much of the manual effort involved in populating a knowledge base entry. For instance, the disclosed techniques can eliminate the effort of manually sifting through knowledge base content thereby streamlining the content creation process. In addition, the inclusion of a review and confirmation functionality ensures that the information produced by the large language model is factual, accurate, and maintains the privacy and security of the knowledge base and users. Alternatively, the natural language output may simply be consumed by a user (e.g., read, heard) and not confirmed, published, or otherwise made available to other users.

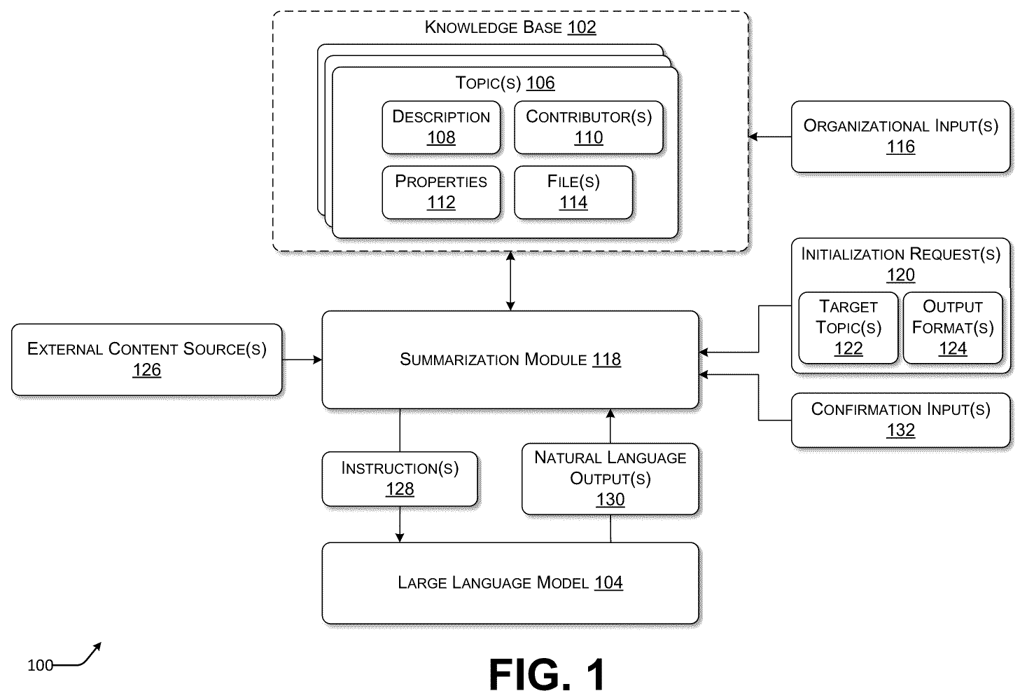

Various examples, scenarios, and aspects that enable knowledge base content generation with large language models are described below with respect to FIGS. 1-7.

FIG. 1 illustrates a system 100 that enhances a knowledge base 102 with the functionalities of a large language model 104. In various examples, a knowledge base 102 can be an organized collection of content (e.g., documents, images, multimedia files) that is specific and/or private to an associated organization such as a research institution, a company, and the like. The knowledge base 102 can be divided into a plurality of constituent topics 106. An individual topic 106 can relate to a specific component of the organization such as a product, a service, a business unit and so forth. Information within a topic 106 can be categorized as one of a description 108, a related contributor 110, a property 112, and a related file 114.

A description 108 can be any information defining the associated topic 106 such as in text, audio, or other form of media and can be generated manually and/or automatically. Oftentimes, a topic 106 can lack a description 108 and hence the system 100 can utilize the large language model 104 to generate a description 108. The contributor 110 can be individuals that contributed to or are otherwise related to the given topic 106 and can be identified through unique identifiers such as usernames. The properties 112 of a topic 106 can define technical and miscellaneous information relevant to the topic 106 such as a title, metadata, tags, related topics, user generated and/or automatically retrieved descriptions, and so forth. The properties 112 can also include security mechanisms such as access controls that can restrict access to the specific topic 106 to specific contributors 110. The files 114 can be any content that contains information pertaining to the topic 106 such as design documents, promotional materials, internal briefings, and so forth.

The content of the knowledge base 102 can be produced and/or curated by users of the knowledge base as well as through automated processes such as artificial intelligence information mining, collectively referred to as organizational inputs 116. In one example, an organizational input 116 can be an employee uploading a document to the knowledge base 102. In another example, the organizational input 116 can be automated process that extracts information from internal activity (e.g., email, chat) for inclusion in the knowledge base 102.

The system 100 can further include a summarization module 118 which can serve as a central management component of the system 100. Accordingly, the summarization module 118 can receive an initialization request 120 specifying a target topic 122 and an output format 124. In an illustrative example, the target topic 122 can be “project alpha” while the output format 124 can be a “definition”. In various examples, the initialization request 120 can be generated manually or automatically in response to a missing description 108, or for a regular time interval (e.g., once a week) as part of an automatic update process (e.g., based on information permissioned to the automated process). The summarization module 118 can process the initialization request 120 by extracting information related to the target topic 122 from the knowledge base 102. For instance, the summarization module 118 can search for a topic 106 that matches the target topic 122 and retrieve any associated files 114. In a specific example, the summarization module 118 can find a matching topic by determining that the properties 112 for a topic define an identifier such as a topic number that matches the target topic 122 defined by the initialization request 120. Moreover, information from the knowledge base 102 can be retrieved by the summarization module 118 based on an access permission of a user associated with the initialization request 120. For example, the user may not have permission to access all the content of the knowledge base 102 and/or the topic 106. As such, the system can omit content (e.g., contributors 110, properties 112, files 114) which the user cannot access from consideration when generating information in response to the initialization request 120. In this way, the disclosed system can enforce access controls for privileged content of the knowledge base 102.

Moreover, the summarization module 118 can also retrieve additional information from an external content source 126 to supplement the information retrieved from the knowledge base 102. Collectively, or in isolation, the knowledge base 102 and/or the external content source 126 can be considered preconfigured data sources. In various examples, the external content source 126 can be publicly available information such as a website, published text, or other media. Information from external content sources 126 can be useful for establishing context at the large language model 104 in scenarios where the target topic 122 involves an external entity such as a customer or partner enterprise. In such scenarios, the summarization module 118 may also have access to enterprise content sources such as databases, record stores, and the like.

Using the target topic 122 and the output format 124 defined by the initialization request 120, along with the information retrieved from a preconfigured data source such as the knowledge base 102 and/or the external content source 126, the summarization module 118 can generate an instruction 128 that directs the large language model 104 to produce a natural language output 130 in accordance with the instruction 128. As will be elaborated upon below, the instruction 128 can be a natural language prompt that expresses the initialization request 120 in a plain language command. In a specific example, the instruction 128 can state “generate a definition for project alpha” where “project alpha” is the target topic 122 and “definition” is the output format 124. Moreover, the instruction 128 can include specific information (e.g., files 114) and phrasing to constrain the natural language outputs 130 of the large language model 104 within the specific context of the knowledge base 102.

Subsequently, the natural language output 130 can be subject to an optional review such as by a human expert, a contributor 110 associated with the topic 106, an automatic review system, or any other suitable method. Pending the review, the summarization module 118 can accordingly receive a confirmation input 132 indicating that the content of the natural language output is factual, accurate, and/or suitable for publication to the knowledge base 102 as a description 108 of a topic 106. In addition, as mentioned above, the properties 112 can impose access restrictions on the topic 106 as well as associated content such as the files 114. These access restrictions can be likewise enforced in the natural language outputs 130 thereby restricting access to the natural language output 130 to certain contributors 110 associated with the topic 106. However, the confirmation input 132 may optionally remove the access restriction of the natural language output 130 and/or the topic 106 to enable publication to a broader audience. Alternatively, the natural language output may simply be consumed by a user (e.g., read, heard) and not confirmed, published, or otherwise made available to other users.

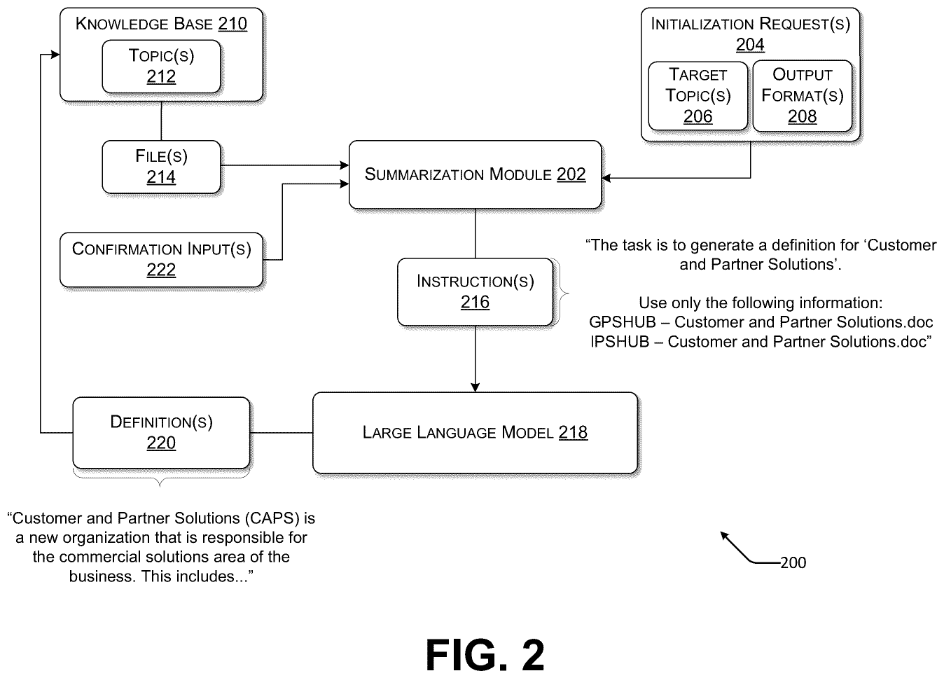

Turning now to FIG. 2, an operational flow 200 is shown and described wherein a summarization module 202 processes an initialization request 204. As discussed above, the initialization request 204 can define a target topic 206 and an output format 208. In response to the initialization request 204, the summarization module 202 can retrieve relevant information from a matching topic 212 of a knowledge base 210. In the present example, the summarization module 202 can retrieve a set of files 214. The summarization module 202 can proceed to generate an instruction 216 using the target topic 206, the output format 208, and the retrieved files 214. In other examples, the summarization module 202 can include other properties of the topic such as existing descriptions, related topics, contributors, messages, and the like. As mentioned above, the instruction 216 can be expressed as a plain language command that directs a large language model 218 to execute a specified task. As shown in the example of FIG. 2, the instruction 216 can be expressed as:

The task is to generate a definition for ‘Customer and Partner Solutions’.
Use only the following information:
GPSHUB - Customer and Partner Solutions.doc
IPSHUB - Customer and Partner Solutions.doc

Where the target topic 206 is “customer and partner solutions” while the output format 208 is a “definition”. In addition, the instruction 216 can include the files 214 as attachments and direct the large language model 218 to “use only the following information.” In this way, the instruction 216 can cause the large language model 218 to generate a definition 220 that summarizes the target topic 206 within the specific context of the knowledge base 210. Stated another way, the instruction 216 can restrict the large language model 218 from incorporating information other than that which is collected by the summarization module 202 and specified by the instruction 216. As shown in FIG. 2, the definition 220 can be a plain language summary describing the nature and function of the target topic 206:

“Customer and Partner Solutions (CAPS) is a new organization that is
responsible for the commercial solutions area of the business. This
includes . . . ”

Based on a review and a subsequent confirmation input 222, the definition 220 can be published to the knowledge base 210 as the description to the topic 212. In an alternative example, the definition 220 can be edited prior to the confirmation input 222 for word choice, phrasing, grammar, style, or other considerations.

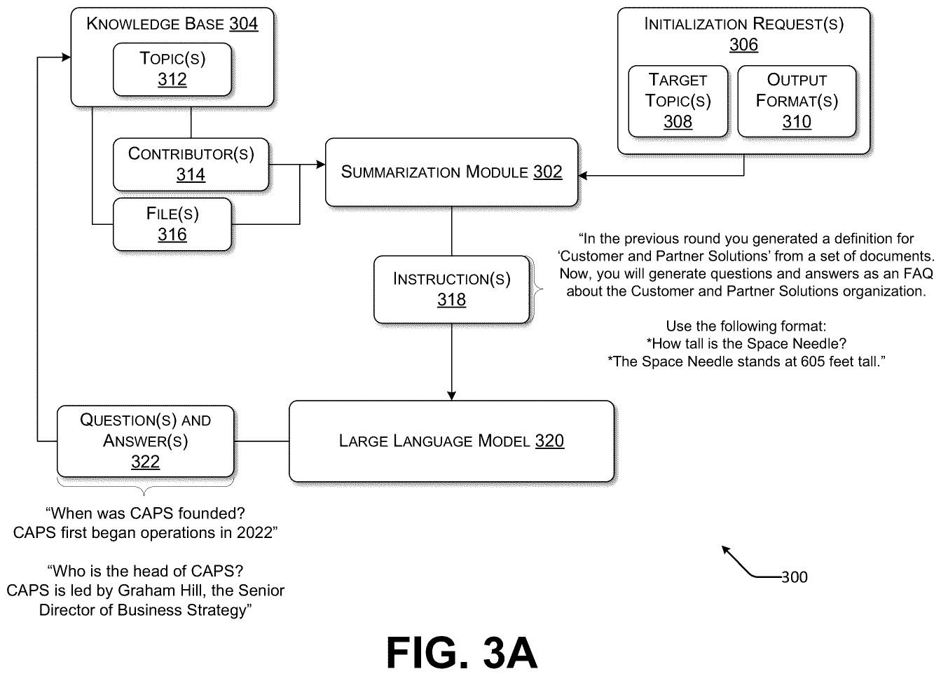

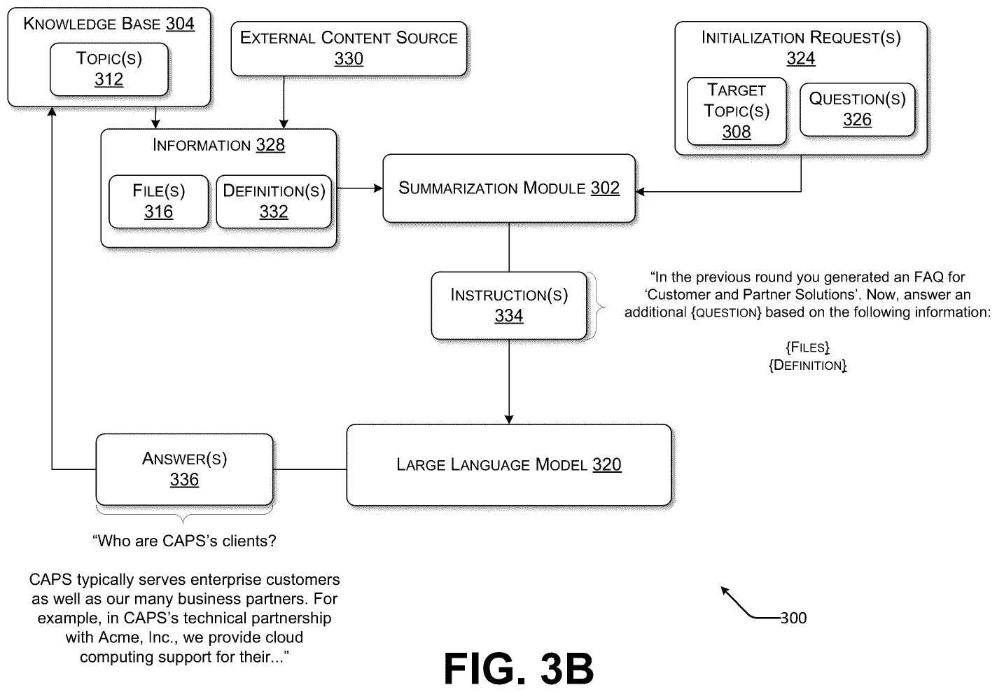

Turning now to FIG. 3A, an operational flow 300 is shown and described wherein a summarization module 302 produces additional information for a knowledge base 304 in response to an initialization request 306. Like in the examples discussed above, the initialization request 306 can define a target topic 308 and an output format 310. In various examples, the operational flow 300 can utilize the results of previous interactions with the summarization module 302. For instance, the current operational flow 300 can utilize the definition 220 and context generated in the example discussed above with respect to FIG. 2. As such, the target topic 308 can still be “Customer and Partner Solutions” while the output format 310 can be a frequently asked questions (FAQ) section for a topic 312.

In response to the initialization request 306, the summarization module 302 can search the knowledge base 304 to determine a topic 312 that matches the target topic 308. Accordingly, the summarization module 302 can retrieve information pertaining to the target topic 308 from the knowledge base 304. In the present example, the summarization module 302 can retrieve contributors 314 and files 316 associated with the topic 312 from the knowledge base 304. The summarization module 302 can proceed to generate an instruction 318 based on the initialization request 306 as well as the contributors 314 and the files 316 retrieved from the knowledge base 304. The instruction 318 can be expressed as shown:

In the previous round you generated a definition for ‘Customer and
Partner Solutions’ from a set of documents. Now, you will generate
questions and answers as an FAQ about the Customer and Partner
Solutions organization.
Use the following format:
*How tall is the Space Needle?
*The Space Needle stands at 605 feet tall.

In various examples, the instruction 318 can reference previous interactions such as by stating that “in the previous round you generated a definition for ‘Customer and Partner Solutions’.” In this way, the instruction 318 can maintain the specific context of a previous interaction to ensure that the large language model 320 produces information that is relevant to the knowledge base 304. Moreover, by referencing “a set of documents” the instruction 318 can maintain the constraints imposed by the previous interaction. In addition, the instruction 318 can express the output format 310 by providing the large language model 320 with examples of an expected output. By directing the large language model 320 to “use the following format” the instruction 318 can ensure that the output of the large language model 320 adheres to a consistent output format 310.

In response to the instruction 318, the large language model 320 can produce a set of questions and answers 322 pertaining to the “Customer and Partner Solutions” topic 312. The questions and answers 322 can be generated based on the information extracted from the knowledge base 304 by the summarization module 302. For example, as shown in FIG. 3A, the questions and answers 322 can provide additional basic information that supplements the previously generated definition 220 such as key people and facts.

“When was CAPS founded? CAPS first began operations in 2022”
“Who is the head of CAPS? CAPS is led by Graham Hill, the Senior
Director of Business Strategy”

In this way, the topic 312 can be automatically populated with essential information thereby eliminating much of the manual effort required to organize content into a readable entry of the knowledge base 304. In addition, synthesizing information in this way enables a user to quickly familiarize themselves with a topic 312 without manually sifting through content.

Turning now to FIG. 3B, the summarization module 302 can proceed to process additional initialization requests 324 using the previously generated information to respond to questions 326 in a freeform question and answer (Q&A) format (i.e., a question-and-answer output format). For example, a user may compose and submit a question 326. Accordingly, the question can be included in an initialization request 324 with the target topic 308. The target topic 308 can be derived from the text of the question 326. For example, the question 326 can ask “who are Customer and Partner Solutions' clients?” As such, the target topic 308 can be inferred to be “Customer and Partner Solutions.”

In response to the initialization request 324, the summarization module 302 can retrieve information 328 from the knowledge base 304 as well as an optional external content source 330. The information 328 can include files 316 from a topic 312 at the knowledge base 304 and definitions 332 of various terms, entities, summaries of the topic 312 and the like. In other examples, the summarization module 202 can include other properties of the topic such as existing descriptions, related topics, contributors, messages, and the like. In a specific example, the summarization module 302 may determine that the question 326 originates from a user who is accessing the knowledge base 304 from an external entity such as a customer or partner organization. In response, the summarization module 302 can reference the external content source 330 for information 328 pertaining to the external entity.

The summarization module 302 can proceed to generate an instruction 334 based on the initialization request 324 and the retrieved information 328. The instruction 334 can be expressed as shown below:

“In the previous round you generated an FAQ for ‘Customer and Partner
Solutions’. Now, answer an additional {question} based on the following
information:
{Files}
{Definition}

Like in the examples discussed above, the instruction can maintain the context of the previous interactions by reference “the previous round” as well as the “FAQ for Customer and Partner Solutions” generated by the large language model 320. Accordingly, the instruction 334 can direct the large language model 334 to “answer an additional question” in reference to the question 326. Moreover, the instruction 334 can constrain the large language model 320 to answering the question 326 using the files 316 and the definitions 332 of the extracted information 328. The large language model 320 can respond to the question 326 with an answer 336 that is tailored to the context in which the question 326 was asked.

For example, the question 326 may ask “who are Customer and Partner Solutions' clients?” and the summarization module may detect that the question 326 was submitted by a user who is affiliated with Acme, Inc. The answer 336 can accordingly state that “CAPS typically serves enterprise customers as well as our many business partners . . . ”, as shown in FIG. 3B. However, the answer may also contain information that is specific to the business relationship between Customer and Partner Solutions and Acme, Inc. (e.g., a technical partnership). As shown throughout the examples discussed above with respect to FIGS. 2-3B, the summarization module can utilize scenario-specific algorithms to generate instructions that best prepare the large language model to provide a desired natural language output. In addition, these scenario-specific algorithms can also selectively include retrieved information in the instructions to ensure relevant outputs. In the present example, the question 326 that is included in the initialization request 324 can cause the output format of the initialization request 324 to be a question-and-answer output format. As such, the natural language output can be the answer 336.

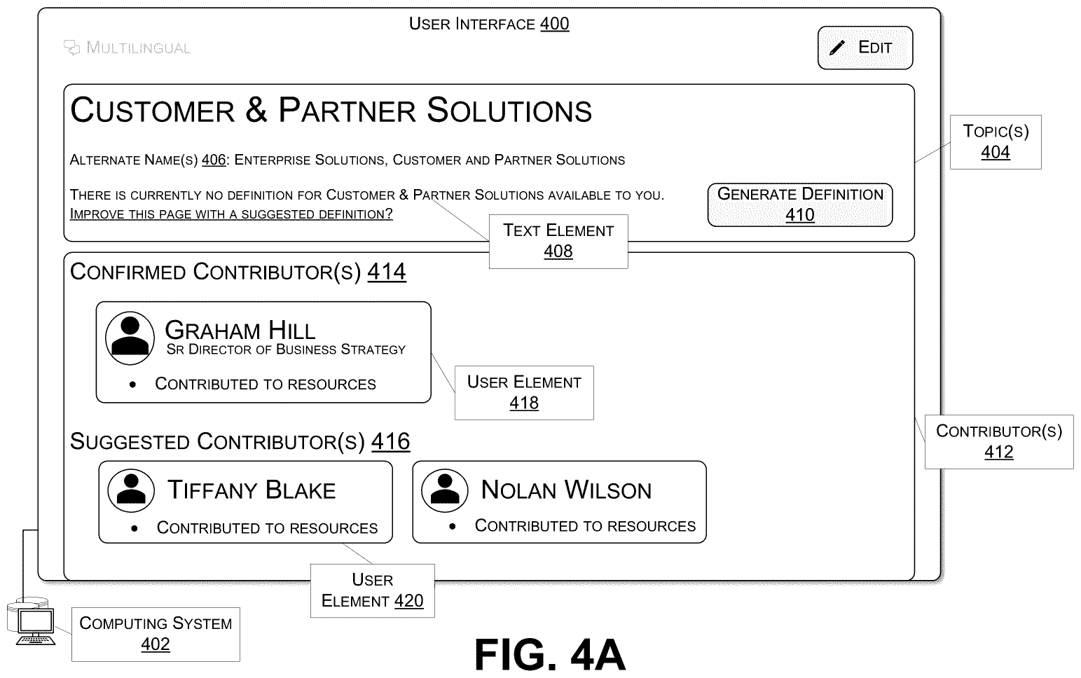

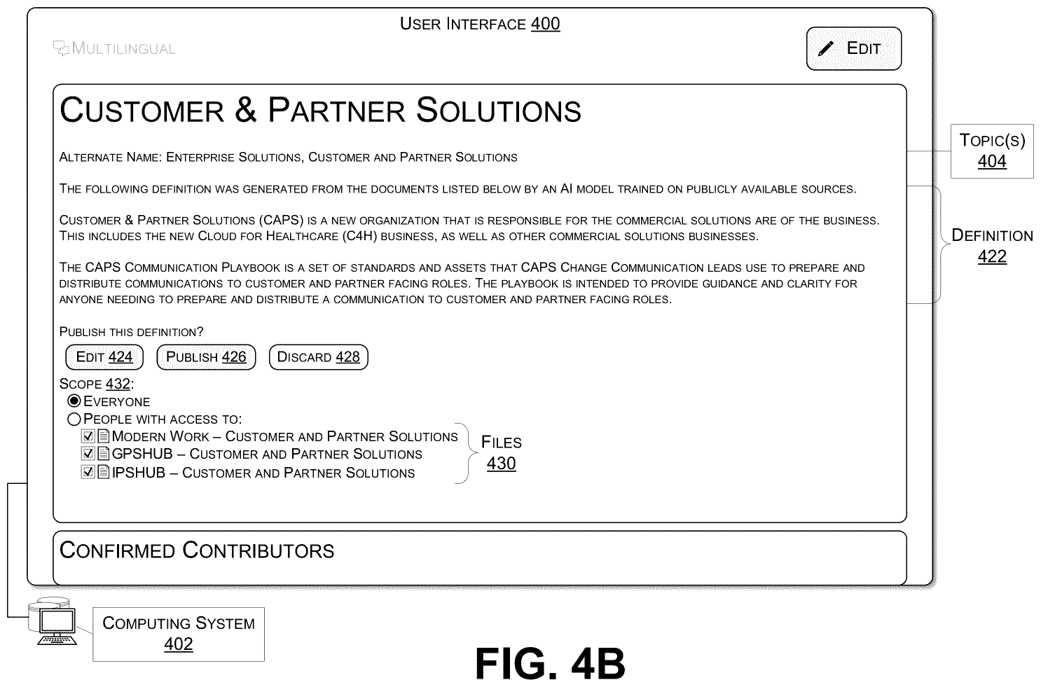

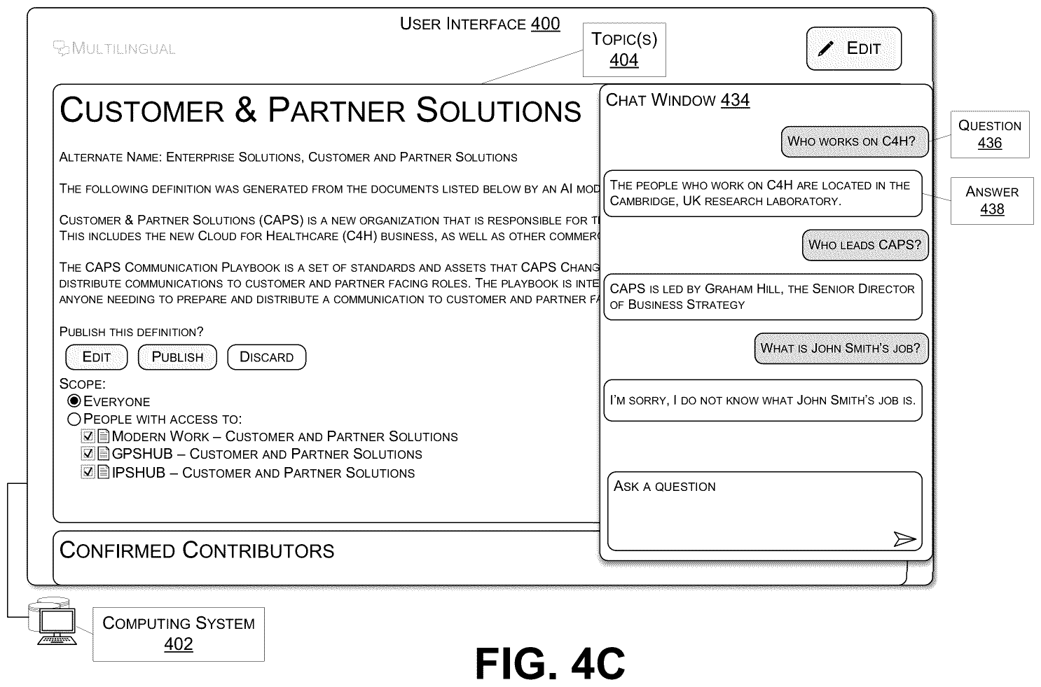

Proceeding to FIG. 4A, an example of a user interface 400 for interacting with a knowledge base is shown and described. In various examples, the user interface 400 can be generated and displayed by a computing system 402. In addition, the computing system 402 can contain and/or access the knowledge base and associated components discussed above such as the summarization module, large language model, and so forth. The user interface 400 of FIG. 4A can display a knowledge base entry of a topic 404 entitled “Customer & Partner Solutions”. The topic 404 can also include a set of alternate names 406 for the topic 404. In some scenarios, the knowledge base can include topics that are differently named but include information that define the same entity (e.g., the same product, the same business department). In this way, the topic 404 can aggregate interrelated information to prevent disparate entries and enhance cohesion of the knowledge base.

Furthermore, the knowledge base can determine that the properties of the topic 404 do not include a definition. Accordingly, the user interface 400 can display a text element 408 to inform a user that “there is currently no definition”. Stated another way, the text element 408 can be displayed in response to determining that the topic 404 does not have an associated definition. In addition, the user interface 400 can display a selectable user interface element 410 that causes the computing system 402 to generate a definition for the topic 404 via a large language model like in the examples discussed above. For example, selecting the user interface element 410 can create an initialization request which can cause a summarization module to retrieve content that is relevant to the “Customer & Partner Solutions” topic 404 and generate a prompt for a large language model. The resultant definition can then be received from the large language model.

The user interface 400 can additionally display a set of contributors 412 that are associated with the topic 404. The contributors 412 can be divided into a set of confirmed contributors 414 and a set of suggested contributors 416. Confirmed contributors 414 can be any contributors 412 having a verified relationship to the topic 404. For instance, the confirmed contributor 414 “Graham Hill” can be identified by a user element 418 as the “senior director of business strategy” and having “contributed to resources” of the topic 404. Conversely, suggested contributors 416 can be any contributors 412 that may have contributed to the knowledge base entry of the topic 404 but may or may not have a verified relationship to the topic 404. For example, another user element 420 can identify a suggested contributor 416 “Tiffany Blake” as having “contributed to resources” while their relationship beyond this may be unknown to the computing system 402.

Turning now to FIG. 4B, in response to an activation of the selectable user interface element 410, the user interface 400 for the knowledge base entry of the topic 404 can be updated with a text definition 422 summarizing the nature and functions of the topic 404. The definition 422 can also include a description of the resources that are available in the knowledge base entry for the topic 404 such as the “CAPS Communication Playbook”. As described above, the definition 422 can be subject to review prior to publication to the knowledge base. Accordingly, the user interface 400 can enable a user to review the definition 422 by displaying an option to edit 424, publish 426, or discard 428 the definition 422.

In the edit option 424, a user can utilize the user interface 400 to modify aspects of the definition 422 such as word choice, phrasing, grammar, correct factual errors, and so forth. In some scenarios, the definition 422 may be unsatisfactory and can be wholly discarded 428. The user may subsequently manually draft a definition 422 or request a new version from the computing system 402. In addition, the user may customize what information is used to generate the definition 422. That is, the information that is retrieved by the summarization module and provided to the large language model can restricted to certain files, documents, sources, and so forth. Should the definition 422 be deemed suitable for publication to the knowledge base, the user can select the publish option 426.

In another example, the information used to generate the definition 422 may contain privileged and/or confidential information that is only accessible by a specific set of users. Stated another way, the definition 422 may synthesize information from a set of files 430 that include access controls that restrict access to the files 430. As such, the definition 422 can be subject to the same access controls. Accordingly, the user interface 400 can provide options for a scope 432 of the definition which can be modified prior to selecting the publish option 426. For instance, the scope 432 can be defined as “everyone” indicating that despite utilizing the access-controlled files 430, the definition 422 has been deemed suitable for viewing by a general audience (e.g., any user with access to the knowledge base). Alternatively, the scope 432 of the definition 422 can be restricted to “people with access to” some of all of the files 430 that were used to generate the definition 422. In this way, despite utilizing a large language model that may be generally accessible (e.g., as a cloud service), the information generated from the large language model can maintain existing information security rules. Furthermore, the information that is used to generate the definition 422 can be retrieved based on a permission level associated with the user requesting the definition 422 via the computing system 402. For example, the user may not have permission to access some of the files 430. In response, the definition 422 can omit the files 430 that the user cannot access from consideration in generating the definition 422. Consequently, the techniques discussed herein can leverage the strong natural language capabilities of large language models while safeguarding the privacy and security of potentially sensitive information stored in the knowledge base.

Turning now to FIG. 4C, an additional functionality of the user interface 400 is shown and described. In addition, to the functionality of generating a definition 422 for a topic 404 as described above, the user interface 400 can also enable a user to ask questions in a freeform manner. For example, a user can utilize a chat window 434 to submit a question 436 regarding the topic 404. To respond to the question 436, the computing system 402 can utilize a large language model to search the knowledge base for pertinent information and compose a reply.

For example, the question 436 can ask “who works on C4H?” an initiative associated with the “Customer & Partner Solutions” organization as stated in the definition 422. In response, the large language model can search for information related to “C4H” in the “Customer & Partner Solutions” topic 404 as well as related topics, internal messages, documents, descriptions, and other content. The large language model can subsequently compose an answer 438 to the question 436 based on this information. For instance, the answer 438 can state that “the people who work on C4H are located in the Cambridge, UK research laboratory.”

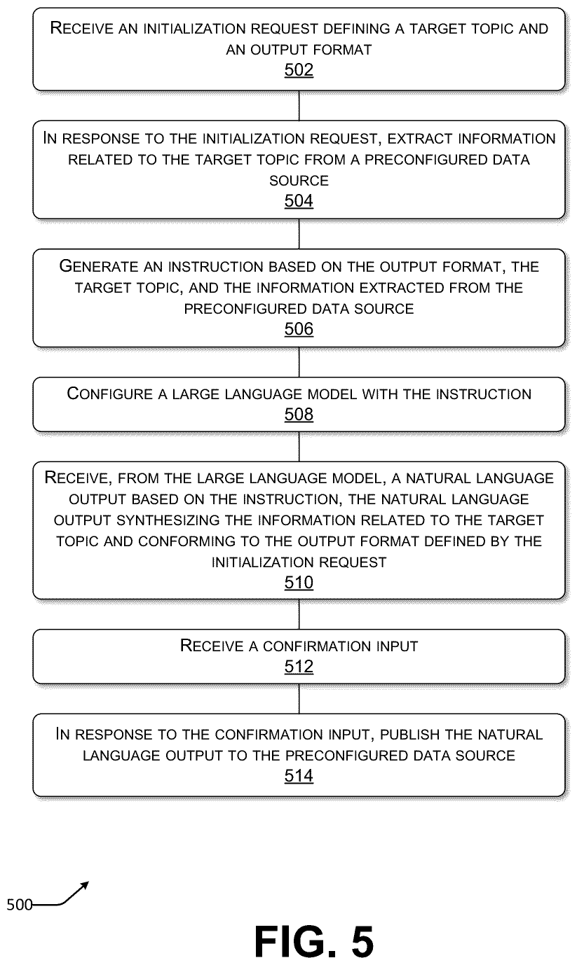

Proceeding to FIG. 5, aspects of a routine 500 for generating knowledge base content using a large language model are shown and described. With reference to FIG. 5, the routine 500 begins at operation 502 where a system receives an initialization request defining a target topic and an output format.

Next, at operation 504, in response to receiving the initialization request, the system extracts information related to the target topic from a knowledge base and/or an external content source.

Then, at operation 506, the system generates an instruction based on the output format, the target topic, and the information extracted from the knowledge base (e.g., information permissioned to the user) and/or an external content source.

Proceeding to operation 508, the system configures (e.g., provides) a large language model with the instruction.

Then, at operation 510, the system receives a natural language output from the large language model that is generated based on the instruction. The natural language output synthesizes the information extracted from the knowledge base and conforms to the output format defined by the initialization request.

Next, at operation 512, the system receives a confirmation input.

Finally, at operation 514, in response to the confirmation input, the system publishes the natural language output to the knowledge base.

For ease of understanding, the process discussed in this disclosure are delineated as separate operations represented as independent blocks. However, these separately delineated operations should not be construed as necessarily order dependent in their performance. The order in which the process is described is not intended to be construed as a limitation, and any number of the described process blocks may be combined in any order to implement the process or an alternate process. Moreover, it is also possible that one or more of the provided operations is modified or omitted.

The particular implementation of the technologies disclosed herein is a matter of choice dependent on the performance and other requirements of a computing device. Accordingly, the logical operations described herein are referred to variously as states, operations, structural devices, acts, or modules. These states, operations, structural devices, acts, and modules can be implemented in hardware, software, firmware, in special-purpose digital logic, and any combination thereof. It should be appreciated that more or fewer operations can be performed than shown in the figures and described herein. These operations can also be performed in a different order than those described herein.

It also should be understood that the illustrated methods can end at any time and need not be performed in their entireties. Some or all operations of the methods, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For example, the operations of the routine 500 can be implemented, at least in part, by modules running the features disclosed herein can be a dynamically linked library (DLL), a statically linked library, functionality produced by an application programing interface (API), a compiled program, an interpreted program, a script, or any other executable set of instructions. Data can be stored in a data structure in one or more memory components. Data can be retrieved from the data structure by addressing links or references to the data structure.

Although the illustration may refer to the components of the figures, it should be appreciated that the operations of the routine 500 may be also implemented in other ways. In addition, one or more of the operations of the routine 500 may alternatively or additionally be implemented, at least in part, by a chipset working alone or in conjunction with other software modules. In the example described below, one or more modules of a computing system can receive and/or process the data disclosed herein. Any service, circuit, or application suitable for providing the techniques disclosed herein can be used in operations described herein.

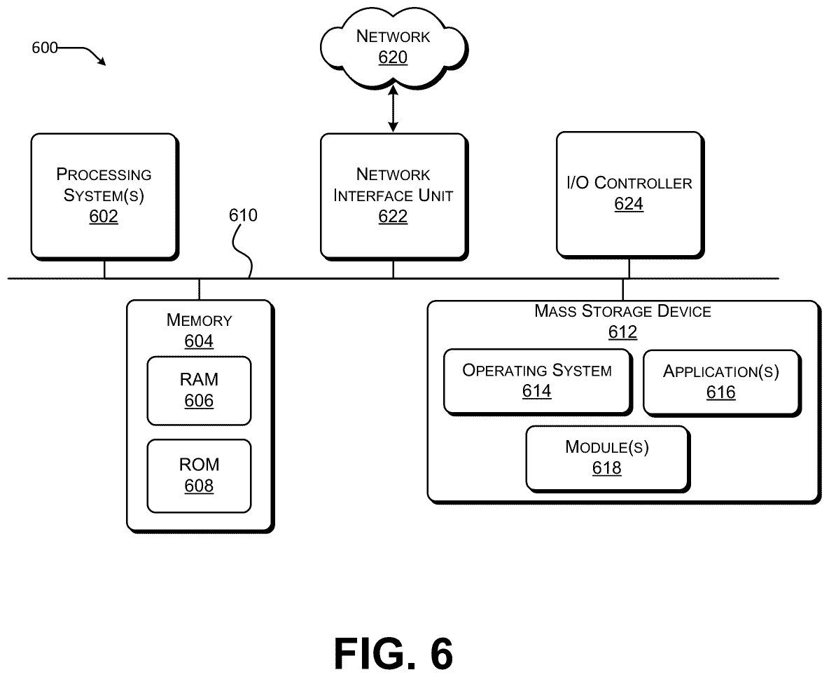

FIG. 6 shows additional details of an example computer architecture 600 for a device, such as a computer or a server configured as part of the cloud-based platform or system 100, capable of executing computer instructions (e.g., a module or a program component described herein). The computer architecture 600 illustrated in FIG. 6 includes processing system 602, a system memory 604, including a random-access memory 606 (RAM) and a read-only memory (ROM) 608, and a system bus 610 that couples the memory 604 to the processing system 602. The processing system 602 comprises processing unit(s). In various examples, the processing unit(s) of the processing system 602 are distributed. Stated another way, one processing unit of the processing system 602 may be located in a first location (e.g., a rack within a datacenter) while another processing unit of the processing system 602 is located in a second location separate from the first location. For example, the processing system 602 can include graphical processing units (GPUs) for executing complex artificial intelligence applications such as large language models. Moreover, the systems discussed herein can be provided as a distributed computing system such as a cloud service.

Processing unit(s), such as processing unit(s) of processing system 602, can represent, for example, a CPU-type processing unit, a GPU-type processing unit, a field-programmable gate array (FPGA), another class of digital signal processor (DSP), or other hardware logic components that may, in some instances, be driven by a CPU. For example, illustrative types of hardware logic components that can be used include Application-Specific Integrated Circuits (ASICs), Application-Specific Standard Products (ASSPs), System-on-a-Chip Systems (SOCs), Complex Programmable Logic Devices (CPLDs), and the like.

A basic input/output system containing the basic routines that help to transfer information between elements within the computer architecture 600, such as during startup, is stored in the ROM 608. The computer architecture 600 further includes a mass storage device 612 for storing an operating system 614, application(s) 616, modules 618, and other data described herein.

The mass storage device 612 is connected to processing system 602 through a mass storage controller connected to the bus 610. The mass storage device 612 and its associated computer-readable media provide non-volatile storage for the computer architecture 600. Although the description of computer-readable media contained herein refers to a mass storage device, the computer-readable media can be any available computer-readable storage media or communication media that can be accessed by the computer architecture 600.

Computer-readable media includes computer-readable storage: media and/or communication media. Computer-readable storage media includes one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including RAM, static RAM (SRAM), dynamic RAM (DRAM), phase change memory (PCM), ROM, erasable programmable ROM (EPROM), electrically EPROM (EEPROM), flash memory, compact disc read-only memory (CD-ROM), digital versatile disks (DVDs), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer-readable storage media, communication media can embody computer-readable instructions, data structures, program modules, or other data in a modulated data signal, such as a carrier wave, or other transmission mechanism. As defined herein, computer storage media does not include communication media. That is, computer-readable storage media does not include communications media consisting solely of a modulated data signal, a carrier wave, or a propagated signal, per se.

According to various configurations, the computer architecture 600 may operate in a networked environment using logical connections to remote computers through the network 620. The computer architecture 600 may connect to the network 620 through a network interface unit 622 connected to the bus 610. The computer architecture 600 also may include an input/output controller 624 for receiving and processing input from a number of other devices, including a keyboard, mouse, touch, or electronic stylus or pen. Similarly, the input/output controller 624 may provide output to a display screen, a printer, or other type of output device.

The software components described herein may, when loaded into the processing system 602 and executed, transform the processing system 602 and the overall computer architecture 600 from a general-purpose computing system into a special-purpose computing system customized to facilitate the functionality presented herein. The processing system 602 may be constructed from any number of transistors or other discrete circuit elements, which may individually or collectively assume any number of states. More specifically, the processing system 602 may operate as a finite-state machine, in response to executable instructions contained within the software modules disclosed herein. These computer-executable instructions may transform the processing system 602 by specifying how the processing system 602 transition between states, thereby transforming the transistors or other discrete hardware elements constituting the processing system 602.

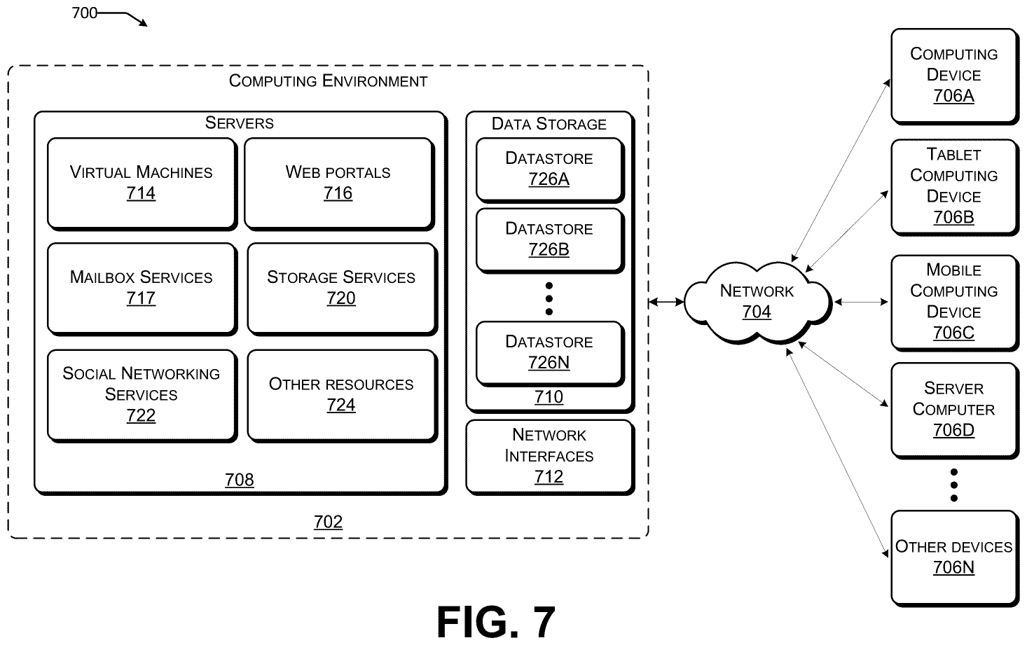

FIG. 7 depicts an illustrative distributed computing environment 700 capable of executing the software components described herein. Thus, the distributed computing environment 700 illustrated in FIG. 7 can be utilized to execute any aspects of the software components presented herein. For example, the distributed computing environment 700 can be utilized to execute aspects of the software components described herein.

Accordingly, the distributed computing environment 700 can include a computing environment 702 operating on, in communication with, or as part of the network 704. The network 704 can include various access networks. One or more client devices 706A-706N (hereinafter referred to collectively and/or generically as “computing devices 706”) can communicate with the computing environment 702 via the network 704. In one illustrated configuration, the computing devices 706 include a computing device 706A such as a laptop computer, a desktop computer, or other computing device; a slate or tablet computing device (“tablet computing device”) 706B; a mobile computing device 706C such as a mobile telephone, a smart phone, or other mobile computing device; a server computer 706D; and/or other devices 706N. It should be understood that any number of computing devices 706 can communicate with the computing environment 702.

In various examples, the computing environment 702 includes servers 708, data storage 610, and one or more network interfaces 712. The servers 708 can host various services, virtual machines, portals, and/or other resources. In the illustrated configuration, the servers 708 host virtual machines 714, Web portals 716, mailbox services 718, storage services 720, and/or social networking services 722. As shown in FIG. 7 the servers 708 also can host other services, applications, portals, and/or other resources (“other resources”) 724.

As mentioned above, the computing environment 702 can include the data storage 710. According to various implementations, the functionality of the data storage 710 is provided by one or more databases operating on, or in communication with, the network 704. The functionality of the data storage 710 also can be provided by one or more servers configured to host data for the computing environment 700. The data storage 710 can include, host, or provide one or more real or virtual datastores 726A-726N (hereinafter referred to collectively and/or generically as “datastores 726”). The datastores 726 are configured to host data used or created by the servers 808 and/or other data. That is, the datastores 726 also can host or store web page documents, word documents, presentation documents, data structures, algorithms for execution by a recommendation engine, and/or other data utilized by any application program. Aspects of the datastores 726 may be associated with a service for storing files.

The computing environment 702 can communicate with, or be accessed by, the network interfaces 712. The network interfaces 712 can include various types of network hardware and software for supporting communications between two or more computing devices including the computing devices and the servers. It should be appreciated that the network interfaces 712 also may be utilized to connect to other types of networks and/or computer systems.

It should be understood that the distributed computing environment 700 described herein can provide any aspects of the software elements described herein with any number of virtual computing resources and/or other distributed computing functionality that can be configured to execute any aspects of the software components disclosed herein. According to various implementations of the concepts and technologies disclosed herein, the distributed computing environment 700 provides the software functionality described herein as a service to the computing devices. It should be understood that the computing devices can include real or virtual machines including server computers, web servers, personal computers, mobile computing devices, smart phones, and/or other devices. As such, various configurations of the concepts and technologies disclosed herein enable any device configured to access the distributed computing environment 700 to utilize the functionality described herein for providing the techniques disclosed herein, among other aspects.

The disclosure presented herein also encompasses the subject matter set forth in the following clauses.

Example Clause A, a method comprising: receiving an initialization request defining a target topic and an output format; in response to receiving the initialization request, extracting, by a processing unit, information related to the target topic from a knowledge base based on a permission level associated with the initialization request; generating an instruction based on the output format, the target topic, and the information extracted from the knowledge base; configuring a large language model with the instruction; receiving, from the large language model, a natural language output that is generated based on the instruction, the natural language output being generated according to the information extracted from the knowledge base and conforming to the output format defined by the initialization request; receiving a confirmation input; in response to receiving the confirmation input, publishing the natural language output to the knowledge base.

Example Clause B, the method of Example Clause A, wherein the initialization request is automatically generated at a regular time interval.

Example Clause C, the method of Example Clause A or Example Clause B, wherein: the output format defined by the initialization request is a definition of the target topic; and the instruction comprises a plain language command causing the large language model to generate the natural language output describing a nature and a function of the target topic.

Example Clause D, the method of any one of Example Clause A through C, further comprising extracting the information from an external content source.

Example Clause E, the method of any one of Example Clause A through D, wherein the instruction further comprises an example of an expected natural language output.

Example Clause F, the method of any one of Example Clause A through E, further comprising: determining that the information extracted from the knowledge base contains a permission control restricting access to the information; and in response to determining that the information extracted from the knowledge base contains a permission control, applying a same permission control to the natural language output.

Example Clause G, the method of Example Clause F, wherein the confirmation input modifies the permission control of the natural language output for publication to the knowledge base.

Example Clause H, a system comprising: a processing unit; and a computer readable medium having encoded thereon computer readable instructions that when executed by the processing unit causes the system to: receive an initialization request defining a target topic and an output format; in response to receiving the initialization request, extract information related to the target topic from a knowledge base; generate an instruction based on the output format, the target topic, and the information extracted from the knowledge base; configure a large language model with the instruction; receive, from the large language model, a natural language output that is generated based on the instruction, the natural language output being generated according to the information extracted from the knowledge base and conforming to the output format defined by the initialization request; receive a confirmation input; in response to receiving the confirmation input, publish the natural language output to the knowledge base.

Example Clause I, the system of Example Clause H, wherein: the knowledge base is associated with an organization that operates the knowledge base; and the initialization request is generated by the organization that operates the knowledge base.

Example Clause J, the system of Example Clause H or Example Clause I, wherein: the output format defined by the initialization request is a definition of the target topic; and the instruction comprises a plain language command causing the large language model to generate the natural language output describing a nature and a function of the target topic.

Example Clause K, the system of any one of Example Clause H through J, wherein the computer readable instructions further cause the system to extract information from an external content source.

Example Clause L, the system of any one of Example Clause H through K, wherein the instruction further comprises an example of an expected natural language output.

Example Clause M, the system of any one of Example Clause H through L, wherein: the output format is a frequently asked questions section for the target topic; and the natural language output is a set of questions and answers.

Example Clause N, the system of any one of Example Clause H through L, wherein: the initialization request further defines a freeform question; the output format is a question-and-answer; and the natural language output is an answer.

Example Clause O, the system of any one of Example Clause H through N, wherein the computer readable instructions further cause the system to: determine that the target topic does not have an associated definition; in response to determining that the target topic does not have the associated definition, display a user interface element within a user interface; receive a selection of the user interface element via the user interface; and generate the initialization request in response to the selection of the user interface element.

Example Clause P, the system of any one of Example Clause H through O, wherein the confirmation input is received via a user interface that enables a review of the natural language output received from the large language model.

Example Clause Q, a computer readable storage medium having encoded thereon computer readable instructions that when executed by a processing unit cause a system to: receive an initialization request defining a target topic and an output format; in response to receiving the initialization request, extract information related to the target topic from a knowledge base; generate an instruction based on the output format, the target topic, and the information extracted from the knowledge base; configure a large language model with the instruction; receive, from the large language model, a natural language output that is generated based on the instruction, the natural language output being generated according to the information extracted from the knowledge base and conforming to the output format defined by the initialization request; receive a confirmation input; in response to receiving the confirmation input, publish the natural language output to the knowledge base.

Example Clause R, the computer readable storage medium of Example Clause Q, wherein the instruction further comprises an example of an expected natural language output.

Example Clause S, the computer readable storage medium of Example Clause Q or Example Clause R, wherein the computer readable instructions further cause the system to: determine that the information extracted from the knowledge base contains a permission control restricting access to the information; and in response to determining that the information extracted from the knowledge base contains a permission control, apply a same permission control to the natural language output.

Example Clause T, the computer readable storage medium of Example Clause S, wherein the confirmation input modifies the permission control of the natural language output for publication to the knowledge base.

Conditional language such as, among others, “can,” “could,” “might” or “may,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example. Conjunctive language such as the phrase “at least one of X, Y or Z,” unless specifically stated otherwise, is to be understood to present that an item, term, etc. may be either X, Y, or Z, or a combination thereof.

The terms “a,” “an,” “the” and similar referents used in the context of describing the invention (especially in the context of the following claims) are to be construed to cover both the singular and the plural unless otherwise indicated herein or clearly contradicted by context. The terms “based on,” “based upon,” and similar referents are to be construed as meaning “based at least in part” which includes being “based in part” and “based in whole” unless otherwise indicated or clearly contradicted by context.

In addition, any reference to “first,” “second,” etc. elements within the Summary and/or Detailed Description is not intended to and should not be construed to necessarily correspond to any reference of “first,” “second,” etc. elements of the claims. Rather, any use of “first” and “second” within the Summary, Detailed Description, and/or claims may be used to distinguish between two different instances of the same element (e.g., two different topics)

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

1. A method comprising:
receiving an initialization request defining a target topic and an output format;
in response to receiving the initialization request, extracting, by a processing unit, information related to the target topic from a knowledge base based on a permission level associated with the initialization request;
generating an instruction based on the output format, the target topic, and the information extracted from the knowledge base;
configuring a large language model with the instruction;
receiving, from the large language model, a natural language output that is generated based on the instruction, the natural language output being generated according to the information extracted from the knowledge base and conforming to the output format defined by the initialization request;
receiving a confirmation input;
in response to receiving the confirmation input, publishing the natural language output to the knowledge base.

2. The method of claim 1, wherein the initialization request is automatically generated at a regular time interval.

3. The method of claim 1, wherein:
the output format defined by the initialization request is a definition of the target topic; and
the instruction comprises a plain language command causing the large language model to generate the natural language output describing a nature and a function of the target topic.

4. The method of claim 1, further comprising extracting the information from an external content source.

5. The method of claim 1, wherein the instruction further comprises an example of an expected natural language output.

6. The method of claim 1, further comprising:
determining that the information extracted from the knowledge base contains a permission control restricting access to the information; and
in response to determining that the information extracted from the knowledge base contains a permission control, applying a same permission control to the natural language output.

7. The method of claim 6, wherein the confirmation input modifies the permission control of the natural language output for publication to the knowledge base.

8. A system comprising:
a processing unit; and
a computer readable medium having encoded thereon computer readable instructions that when executed by the processing unit causes the system to:
receive an initialization request defining a target topic and an output format;
in response to receiving the initialization request, extract information related to the target topic from a knowledge base;
generate an instruction based on the output format, the target topic, and the information extracted from the knowledge base;
configure a large language model with the instruction;
receive, from the large language model, a natural language output that is generated based on the instruction, the natural language output being generated according to the information extracted from the knowledge base and conforming to the output format defined by the initialization request;
receive a confirmation input;
in response to receiving the confirmation input, publish the natural language output to the knowledge base.

9. The system of claim 8, wherein:
the knowledge base is associated with an organization that operates the knowledge base; and
the initialization request is generated by the organization that operates the knowledge base.

10. The system of claim 8, wherein:
the output format defined by the initialization request is a definition of the target topic; and
the instruction comprises a plain language command causing the large language model to generate the natural language output describing a nature and a function of the target topic.

11. The system of claim 8, wherein the computer readable instructions further cause the system to extract information from an external content source.

12. The system of claim 8, wherein the instruction further comprises an example of an expected natural language output.

13. The system of claim 8, wherein:
the output format is a frequently asked questions section for the target topic; and
the natural language output is a set of questions and answers.

14. The system of claim 8, wherein:
the initialization request further defines a freeform question;
the output format is a question-and-answer; and
the natural language output is an answer.

15. The system of claim 8, wherein the computer readable instructions further cause the system to:
determine that the target topic does not have an associated definition;
in response to determining that the target topic does not have the associated definition, display a user interface element within a user interface;
receive a selection of the user interface element via the user interface; and
generate the initialization request in response to the selection of the user interface element.

16. The system of claim 8, wherein the confirmation input is received via a user interface that enables a review of the natural language output received from the large language model.

17. A computer readable storage medium having encoded thereon computer readable instructions that when executed by a processing unit cause a system to:
receive an initialization request defining a target topic and an output format;
in response to receiving the initialization request, extract information related to the target topic from a knowledge base;
generate an instruction based on the output format, the target topic, and the information extracted from the knowledge base;
configure a large language model with the instruction;
receive, from the large language model, a natural language output that is generated based on the instruction, the natural language output being generated according to the information extracted from the knowledge base and conforming to the output format defined by the initialization request;
receive a confirmation input;
in response to receiving the confirmation input, publish the natural language output to the knowledge base.

18. The computer readable storage medium of claim 17, wherein the instruction further comprises an example of an expected natural language output.

19. The computer readable storage medium of claim 17, wherein the computer readable instructions further cause the system to:
determine that the information extracted from the knowledge base contains a permission control restricting access to the information; and
in response to determining that the information extracted from the knowledge base contains a permission control, apply a same permission control to the natural language output.

20. The computer readable storage medium of claim 19, wherein the confirmation input modifies the permission control of the natural language output for publication to the knowledge base.
